(19) United States
(12) Patent Application Publication
(10) Pub. No.: US 2010/0182263 A1
(43) Pub. Date: Jul. 22, 2010

(54) TOUCHPAD ASSEMBLY WITH TACTILE FEEDBACK

(75) Inventors: Antti Tapani Aunio, Oulu (FI); Mika Petteri Kauhanen, Espoo (FI); Nikolaj Bestle, Calabasas, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/664,185

(22) PCT Filed: Apr. 7, 2008
(86) PCT No.: PCT/EP2008/054161

§ 371 Date: Dec. 11, 2009

(30) Foreign Application Priority Data
Jun. 14, 2007 (IB) PCT/IB2007/052261

(51) Int. Cl. G06F 3/041; G08B 6/00

(52) U.S. Cl. 345/173; 340/407.2

(57) ABSTRACT

An assembly for a terminal device, the assembly comprises a frame; a panel operable to receive a haptic user input; a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and a force sensor operable to detect a haptic input applied to the panel. It also includes a transducer, for instance a piezo actuator, operable to provide a tactile feedback to the user through the panel.

### FIELD OF THE INVENTION

The present invention relates to an assembly for a terminal device.

### BACKGROUND TO THE INVENTION

WO94/02921 discloses a touch panel in which force sensitive elements are located at supports at four corners of the panel. Circuits compare the forces exerted at supports to determine the location on the panel which is being touched.

Conventionally, terminal devices such as mobile communications devices have been provided with a display for providing a user interface and displaying information, and a keypad for entering data.

It is becoming increasingly common for terminal devices to be provided with a touch-sensitive display. The touch-sensitive display can be provided in addition to, or instead of, a keypad. To enter information, the user presses on the relevant part of the display using their finger or a tool such as a stylus. In some devices, the user can also drag items or highlight areas on the display by stroking the display. It is known also to provide terminal devices with touch-sensitive panels which do not have a display function.

Another disadvantage of a touch-sensitive input panel is that instant feedback may not be provided to the user when the display is pressed. For example, if a user enters information using a keypad, typically the key moves downward when the user presses it, and thus the user is assured that the entry of information has been registered. When the user presses on a conventional touch-sensitive input panel such as a display, the displayed information may not change immediately. In the absence of any other acknowledgement of data entry, the user would not know that the press had been registered and may continue to press the input panel. Ultimately, this may lead to frustration for the user.

The invention was made in this context.

### SUMMARY OF THE INVENTION

A first aspect of the present invention provides an assembly for a terminal device, the assembly comprising:
a frame;
a panel operable to receive a haptic user input;
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
a force sensor operable to detect a haptic input applied to the panel.

This can allow the force applied to the pad to be determined. The force so determined can then be used to improve the user experience. For instance, a force above a threshold can be used to determine that a haptic input has occurred. Alternatively or additionally, different levels of force can be used to different effects, i.e. a relatively high force gives rise to a different operation than a relatively low force.

The panel may be a touch-sensitive input panel. In this case, the force as detected by the force sensor may be used as a separate input to an input provided by the touch-sensitive input panel.

The member may comprise a plurality of rigid lever members linked to each other by a variable length connection. The lever members can be rectangular or can have another suitable shape, such as a “U” shape. The variable length joint may be a pin and slot joint.

The member may comprise two rigid lever members. The two rigid lever members may be substantially the same size. Thus, if the panel is supported centrally on the member, the displacement of the panel can be perpendicular to the plane of the panel.

The frame may comprise a base having four sidewalls to define a rectangular cavity, the member being pivotally connected to two opposing sidewalls of said four sidewalls.

A second aspect of the present invention provides an assembly for a terminal device, the assembly comprising:
a frame;
a panel operable to receive a haptic user input;
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
a transducer operable to provide a tactile feedback to the user through the panel

This allows tactile feedback to a user making a haptic input.

A third aspect of the invention provides an assembly for a terminal device, the assembly comprising:
frame means;
panel means operable to receive a haptic user input;
member means pivotally connected to the frame to define two or more pivot axes and supporting the panel at locations distinct from the pivot axes, the member means being arranged in such a way that the length of a part of the member means connecting points on the two pivot axes varies in response to the haptic user input, and such that the panel means is displaced relative to the frame means as said length varies, and
force sensor means operable to detect a haptic input applied to the panel means.

A fourth aspect of the invention provides an assembly for a terminal device, the assembly comprising:
frame means;
panel means operable to receive a haptic user input;
member means pivotally connected to the frame means to define two or more pivot axes and supporting the panel means at locations distinct from the pivot axes, the member means being arranged in such a way that the length of a part of the member means connecting points on the two pivot axes varies in response to the haptic user input, and such that the panel means is displaced relative to the frame means as said length varies, and
transducer means operable to provide a tactile feedback to the user through the panel means.

A fifth aspect of the invention provides a method of operating an assembly for a terminal device, the assembly comprising:
a frame;
a panel operable to receive a haptic user input; and
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
the method comprising using a force sensor to detect a haptic input applied to the panel.

A sixth aspect of the invention provides a method of operating an assembly for a terminal device, the assembly comprising:
a frame;
a panel operable to receive a haptic user input; and
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies,
the method comprising using a transducer to provide a tactile feedback to the user through the panel.

### BRIEF DESCRIPTION OF THE DRAWINGS

Embodiments of the present invention will now be described by way of example only, with reference to the accompanying drawings in which:

FIG. 1A illustrates a cross section of a first embodied assembly, in the form of a display assembly, according to the present invention, in a first position;

FIG. 1B illustrates the FIG. 1A assembly in a second position;

FIG. 2A illustrates a cross section of a second embodied assembly, in the form of a display assembly, according to the present invention;

FIG. 2B illustrates the FIG. 2A assembly in a second position;

FIG. 3A illustrates a cross section of a first embodied assembly, in the form of a display assembly, according to the present invention, in a first position;

FIG. 3B illustrates the FIG. 3A assembly in a second position;

FIG. 4A illustrates a cross section of a second embodied assembly, in the form of a display assembly, according to the present invention; and

FIG. 4B illustrates the FIG. 4A assembly in a second position.

In the Figures, reference numerals are re-used for like elements throughout.

### DETAILED DESCRIPTION OF EMBODIMENTS OF THE INVENTION

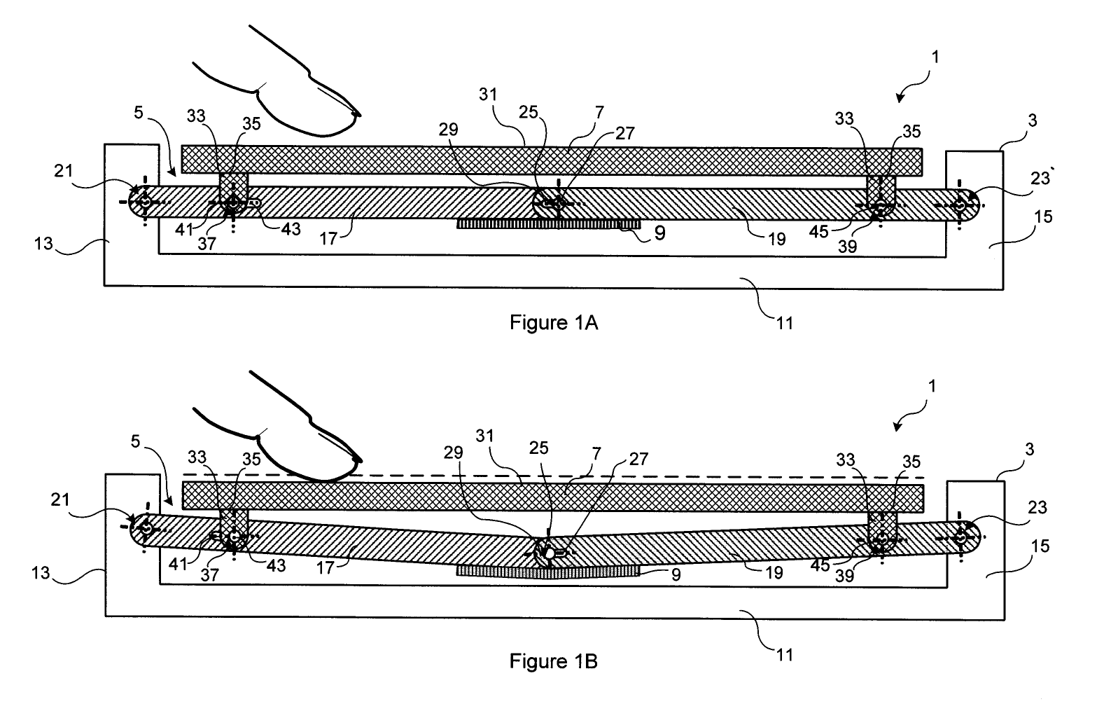

Referring firstly to FIGS. 1A and 1B, an assembly is a display assembly 1 and comprises a frame 3, a supporting member 5, a touch-sensitive display 7 and a force sensor 9. In this example, the display assembly 1 forms part of a mobile communications device (not shown).

The frame 3 has a base 11, a first sidewall 13 and a second sidewall 15 opposing the first sidewall 13. The frame 3 also has third and fourth sidewalls (not shown) perpendicular to the first and second sidewalls, to form a rectangular cavity for containing the supporting member 5, the display 7, and the force sensor 9.

The supporting member 5 comprises a first rigid lever member 17 and a second rigid lever member 19. The first and second lever members 17, 19 have a generally rectangular form with a length extending horizontally in the Figure and a width extending perpendicular to the plane of the Figure. In this example, the first and second rigid lever members 17, 19 are of equal length and each has a length slightly greater than the distance between the first sidewall 13 and the second sidewall 15.

The first rigid lever member 17 is pivotally connected at a first edge to the first sidewall 13 to define a first pivot axis 21. The second rigid lever member 19 is pivotally connected at a first edge to the second sidewall 15 to define a second pivot axis 23. These pivot connections can be provided by any suitable means. In this example, each of the pivot connections is provided by a pin and hole arrangement.

The first rigid lever member 17 and the second rigid lever member 19 are pivotally connected to each other at respective second edges, which are opposite to the first edges, to define a third pivot axis 25. The pivot connection is provided by a two pins 27 on the first lever member 17 threaded through two slots 29 on the second lever member 19 to form a pin and slot joint. Each pin 27 protrudes from the first lever member 17 near to and parallel to the second edge. Each slot 29 is provided near the second edge of the second lever member 19.

The display 7 has an upper surface 31 that is touch-sensitive. Thus, when a user provides a haptic user input to the upper surface 31 of the display 7, for example by touching the display 7 with a fingertip, the display 7 and associated circuitry (not shown) is operable to determine the location of the user input. The display 7 may for instance be a resistive or capacitive touch screen or touch window.

The display 7 is rectangular, and has dimensions slightly smaller than the rectangular cavity of the frame 3. The display 7 is not directly coupled to the frame 3. The display 7 is supported by the supporting member 5 to be parallel to the base 11 of the frame 3. This is achieved by four legs 33 (only two of which are shown in the Figures) each extending from the lower surface 35 of a corner of the display 7 to the supporting member 5. Advantageously, each of the four legs 33 is equally spaced from its respective corner of the display 7. Advantageously, the legs 33 are all equal in height.

Two of the legs 33 are pivotally connected to the first lever member 17 to define a fourth pivot axis 37. The pivot connection is provided by a pin 41 fixed to two of the legs 33, the pin 41 is threaded through respective slots 43 on the first lever member 17 to form a pin and slot joint. The other two of the legs 33 are pivotally connected to the second lever member 19 to define a fifth pivot axis 39. The pivot connection is provided by a pin 45 fixed to each of the legs 33. The pin 45 is threaded through respective holes (not shown) on the second lever member 19.

The distance between the fourth pivot axis 37 and the fifth pivot axis 39 is less than the distance between the first pivot axis 21 and the second pivot axis 23.

In this embodiment, the force sensor 9 is described as being a strain gauge, although this non-limiting. However, certain advantages may arise from the use of a strain gauge.

The strain gauge 9 is coupled to the lowermost surfaces of the first and second lever members 17, 19. The strain gauge 9 is coupled to the first and second lever members 17, 19 at the location of the parts adjacent the third pivot axis 25. The coupling may be achieved in any suitable manner For instance, the strain gauge 9 may be coupled to the first and second lever members 17, 19 by a bonding adhesive. The strain gauge 9 may be laminated to the first and second lever members 17, 19.

In this example, the strain gauge 9 detects displacement of the display 7 relative to the frame 3 by detecting movement of the second lever member 19 relative to the first lever member 17. The relative movement is a bending movement at the pivot point 23. The relationship between the movement of the first and second lever members 17, 19 and the displacement of the display 7 is described in further detail below.

Referring in particular to FIG. 1A, if there is no force applied to the display 7, the display assembly 1 is in a first position. In the first position, the supporting member 5 forms a straight line, i.e. the first lever member 17 and the second lever member 19 are parallel, and the display 7 is in a raised position. The strain gauge 9 is relatively relaxed, or unstressed, in the first position.

In this example, the supporting member 5 is held in a straight line position i.e. the first and second lever members 17, 19 are not angled with respect to one another, by means of resilience in the strain gauge 9. In other examples (not shown), the supporting member may be held in a straight line position by other means, for example by means of a compression spring coupled between the base 11 of the frame 3 and the third pivot point 25, or by means of resilience within the supporting member 5 itself.

Referring now to FIG. 1B, when a user presses the display 7 with a fingertip, or provides some other haptic input to the display 7, a force is applied via the legs 33 to the fourth pivot point 37 of the first lever member 17 and the fifth pivot point 39 on the second lever member 17. This results in a first moment being applied to the first lever member 17. This also results in a second moment being applied to the second lever member 19. This causes the first lever member 17 and the second lever member 19 to rotate such that their second edges move towards the base 11 of the frame 9. The pin and slot joint at the third pivot point 25 allows the length of the supporting member 5 to increase, thus allowing the supporting member 5 to form a shallow “V” shape.

By virtue of this arrangement, displacement of the display 7 relative to the frame 3 results in a change in the force applied to the strain gauge 9. Thus, the output of the strain gauge 9 allows the force applied to the display 7 to be calculated or inferred. The force experienced by the strain gauge 9 results in a change in the resistance thereof. The resistance can be detected using a Wheatstone bridge, for instance. The force experienced by the strain gauge 9 can be calculated from the resistance.

The force experienced by the strain gauge 9 is dependent on the extent of movement of the display 7 relative to the frame 3. The greater the movement, the greater the force experienced by the strain gauge 9.

Strain gauges typically have good sensitivity. They also typically have good linearity characteristics. Thus, the use of the strain gauge 9 allows the displacement of the display 7 relative to the frame 3 to be determined easily and accurately. Since the displacement of the display 7 relative to the frame 3 is independent of the location at which force is applied to the display 7, the measured force is not dependent on the location of the haptic input. Put another way, the measured force is not a function of the location of the haptic input. Put yet another way, the arrangement provides a uniform response.

Strain gauges also have the advantages of being robust and compact.

The skilled person will understand the relationship between the force applied as a haptic input and the resulting displacement of the display 7 relative to the frame 3. The skilled person will understand in particular that the relationship is a function of time, speed of movement, resilience of the mechanism and inertia.

Importantly, the measurement of displacement or force can be achieved using a single strain gauge. This is able to provide cost savings and reduced weight compared to a corresponding arrangement including plural strain gauges.

The mechanism provides tactile feedback, as will now be explained.

As the fourth pivot axis 37 on the first lever member 17 and the fifth pivot axis 39 on the second lever member 19 move towards the base 11, the display 7 also moves towards the base 11. The difference in the distance between the fourth pivot axis 37 and the fifth pivot axis 39 in a direction parallel to the base is accounted for by the slot 43 on the fourth pivot axis 37. Movement of the display 7 towards the base 11 provides an immediate tactile feedback to the user that the input has been registered. The effect of the tactile feedback can be increased by designing the arrangement such that the display 7 encounters sudden resistance to further movement once a certain travel of the display 7 has occurred. This may be achieved in any suitable way.

Furthermore, as haptic input results in displacement of the display 7 relative to the frame 3, the changing resistance of the strain gauge 9 is detected by circuitry (not shown). The circuitry infers from the resistance of the strain gauge 9 that the user has provided a haptic input to the display 7. This may involve comparing the output of the strain gauge 9 to a threshold level. It may alternatively be carried out in any other suitable way. The circuitry is responsive to this detection to sense the location of the haptic input on the display 7, using outputs of the display 7, and provide the location information to an operating system which manages operation of the host mobile communications device. The operating system can then provide appropriate signals to interested software applications. As the output of the strain gauge 9 is used to detect that displacement of the display 7 relative to the frame 3 has occurred before the location is sensed and a response is generated, the accuracy of detection of user inputs is improved.

The associated circuitry or the operating system may involve a timer, and the response may be dependent on the length of time that the display 7 is displaced relative to the frame 3, as detected from the output of the strain gauge 9. For example, if the display 7 is displaced relative to the frame 3 by a user pressing the display 7 with a fingertip and then lifting their finger, returning the display assembly to the first position, before expiration of a first timer, a first response may be generated. The location of the haptic input is sensed in response to the detection of the release of the display 7, as detected from the output of the strain gauge 9, and the first response is carried out. The first response may be opening by the operating system or an application of a new page that corresponds to an icon or text displayed at the detected location.

Alternatively, if the release of the display 7, as detected from the output of the strain gauge 9, does not occur until after the first timer expires, other actions may be taken. For example, if after the predetermined first amount of time the detected location of the fingertip on the upper surface 31 of the display has not changed, a second response may be generated. The second response may be displaying a menu by an application.

If the sensed location of the fingertip on the upper surface 31 of the display changes whilst the display 7 is displaced relative to the frame 3, as detected from the output of the strain gauge 9, the circuitry or operating system operates to monitor the location of the haptic input on the display 7 until the display 7 returns to the unactuated position. This allows e.g. selection of text on the display or dragging of items around the display.

In other examples, the location of the haptic input may be sensed before the display 7 is displaced relative to the frame 3, as detected from the output of the strain gauge 9, but information on the detected location may only be captured, in the sense that the information is put to use, upon detection that the display 7 is displaced relative to the frame 3, as detected from the output of the strain gauge 9. The location of the haptic input may be sensed before the display 7 is displaced relative to the frame 3 by a predetermined amount, as detected from the output of the strain gauge 9, but information on the detected location may only be captured, in the sense that the information is put to use, upon detection that the display 7 is displaced relative to the frame 3 by the predetermined amount, as detected from the output of the strain gauge 9.

In an alternative embodiment, the strain gauge 9 is used as an alternative means for detecting a user input. In this embodiment, detection of displacement of the display 7 relative to the frame 3, as detected from the output of the strain gauge 9, is used as described in any of the alternatives above for detecting the location(s) and nature of a haptic input. However, the touch sensitive display 7 also functions conventionally in the sense that it is able to determine without involvement of the strain gauge 9 what is the location(s) and nature of a haptic input. These two different techniques for detecting haptic input can occur in parallel, i.e. a haptic input can be detected and acted on following displacement of the display 7 relative to the frame 3, as detected from the output of the strain gauge 9, even if the haptic input is not detected conventionally. Alternatively, the haptic input can be detected and acted on conventionally even if the haptic input is not detected through the output of the strain gauge 9.

In other embodiments, the arrangement is used to react to user inputs differently. In particular, the arrangement is used in a two-stage input process hereafter termed ‘touch-click’. In touch-click, the location of a haptic user input is detected using the touch-sensitive display 7, and this input is used by the operating system and/or an application to highlight an icon or other item displayed at the appropriate location on the display. Subsequently displacement of the display 7 relative to the frame 3, as detected from the output of the strain gauge 9, is used by the operating system and/or application to activate whatever is denoted by the icon or item. To achieve this, a user merely needs to displace the touch-sensitive display 7 relative to the frame 3 by pressing the display 7. Thus, two inputs can be achieved through a single movement, whereas in the corresponding prior art arrangement it would have been necessary to remove the stylus or finger between first and second touches of the touch-sensitive display.

It will be appreciated that the effectiveness of this mode of operation depends on the sensitivity of the display. To achieve the above-described operation, the touch-sensitive display needs to be sufficiently sensitive that it detects haptic user input before displacement of the display 7 relative to the frame 3 is detected from the output of the strain gauge 9. This can be achieved through suitable setting of the threshold value to which the output of the strain gauge 9 is compared. With a less sensitive touch-sensitive display, or with a suitably selected threshold value to which the output of the strain gauge 9 is compared, the same effect can be achieved but with detection of displacement of the display 7 relative to the frame 3 triggering a location sensing which results in highlighting of an icon or item followed by haptic input detection solely through the touch-sensitive display 7 triggering activation of whatever is denoted by the icon or item.

The distance between the first pivot axis 21 and the fourth pivot axis 37 is equal to the distance between the second pivot axis 23 and the fifth pivot axis 39. Thus, the display 7 moves parallel to the base 11 of the frame 3 when a force is applied.

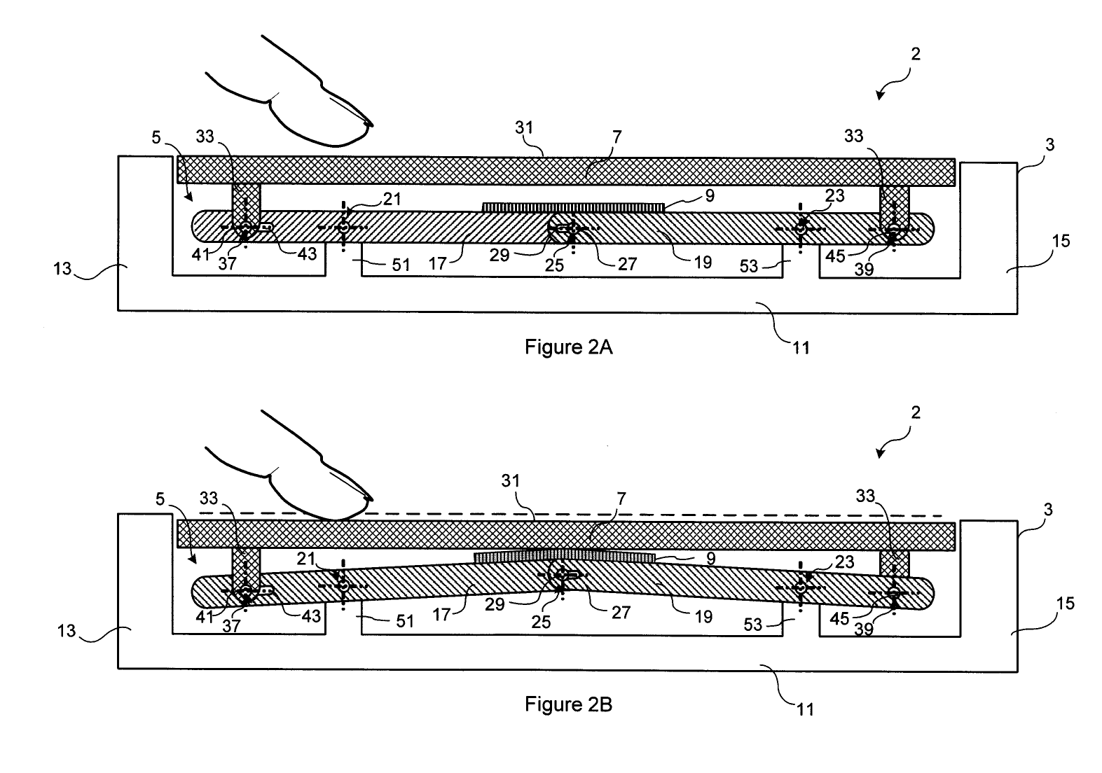

Referring now to FIG. 2A and FIG. 2B, a second embodied assembly, in the form of a display assembly 2, also comprises a frame 3, a supporting member 5, a touch-sensitive display 7 and a force sensor, in the form of a strain gauge 9.

The frame 3 has a base 11, a first sidewall 13 and a second sidewall 15 opposing the first sidewall 13. The frame 3 also has third and fourth sidewalls (not shown) perpendicular to the first and second sidewalls, to form a rectangular cavity for containing the supporting member 5, the display 7, and the strain gauge 9. The frame 3 also comprises a first support 51 and a second support 53 upstanding from the base 11 inside the rectangular cavity. The first support 51 and the second support 53 are arranged to support the supporting member 5 as described below.

The supporting member 5 has substantially the same structure as described with reference to the FIG. 1A display assembly 1. However, in this embodiment the first lever member 17 and the second lever member 19 are not pivotally connected to the first wall 13 and the second wall 15 respectively of the frame 3. Instead, the first lever member 17 is pivotally connected to the first arm 51 to define the first pivot axis 21 and the second lever member 19 is pivotally connected to the second arm 53 to define the second pivot axis 23.

The display 7 has substantially the same structure as described with reference to the FIG. 1A display assembly 1. In this embodiment, the distance between the fourth pivot axis 37 and the fifth pivot axis 39 is greater than the distance between the first pivot axis 21 and the second pivot axis 23.

The strain gauge 9 is coupled to the uppermost surfaces of the first and second lever members 17, 19. The strain gauge 9 is coupled to the first and second lever members 17, 19 at the location of the parts adjacent the third pivot axis 25. The coupling may be achieved in any suitable manner. For instance, the strain gauge 9 may be coupled to the first and second lever members 17, 19 by a bonding adhesive. The strain gauge 9 may be laminated to the first and second lever members 17, 19.

Referring in particular to FIG. 2A, if there is no force applied to the display 7, the display assembly 2 is in a first position. In the first position, the supporting member 5 forms a straight line, i.e. the first lever member 17 and the second lever member 19 are parallel, and the display 7 is in a raised position. The strain gauge 9 is relatively relaxed, or unstressed, in the first position.

Referring now to FIG. 2B, when a user presses the display 7 with a fingertip, or provides some other haptic input to the display 7, a force is applied via the legs 33 to the fourth pivot point 37 of the first lever member 17 and the fifth pivot point 39 on the second lever member 19. As described with reference to the FIG. 1B display assembly, this causes the first lever member 17 and the second lever member 19 to rotate. Since, in this example, the force is applied on the opposite sides to the first and second pivot axes 21, 23, this causes the first lever member 17 and the second lever member 19 to rotate in the opposite direction i.e. the first lever member 17 and the second lever member 19 rotate such that their second edges move away from the base 11.

This rotation also causes the first edges of the first and second lever members 17, 19 to move towards the base 11. Thus the display 11 moves towards the base, and the strain gauge 9 is stretched, or stressed. Therefore, the second embodied display assembly 2 behaves similarly to the first embodied display assembly 1 in response to a haptic user input.

As such, by virtue of this arrangement, displacement of the display 7 relative to the frame 3 results in a change in the force applied to the strain gauge 9. Thus, the output of the strain gauge 9 allows the force applied to the display 7 to be calculated or inferred. The force experienced by the strain gauge 9 results in a change in the resistance thereof. The resistance can be detected using a Wheatstone bridge, for instance. The force experienced by the strain gauge 9 can be calculated from the resistance.

The force experienced by the strain gauge 9 is dependent on the extent of movement of the display 7 relative to the frame 3. The greater the movement, the greater the force experienced by the strain gauge 9.

In the above described examples, the supporting member 5 comprises two rectangular rigid lever members 17, 19 linked by a pin and slot joint. In other examples, the supporting member 5 can have a different structure, provided that it is arranged to have a variable length such that it can be deformed to allow the display 7 to move relative to the frame 3 in response to a haptic user input. For example, the lever members 15, 17 may be replaced by components which provide the same or similar function. The first and second components may each have a “U” shape in the plane of the lever members 15, 17. The “U” shape of the first component may be formed by two rectangular limbs perpendicular to the first pivot axis 21 joined by a base having an axis coinciding with the first pivot axis 21. Similarly, the “U” shape of the second component may be formed by two rectangular limbs perpendicular to the second pivot axis 23 joined by a base in line with the second pivot axis 23. Thus, when linked together, the U shaped component form a supporting member in the shape of a rectangle with a central rectangular hole. This structure can allow circuitry, or other components, to be placed in the same plane as the supporting member 5.

In yet another example, the supporting member 5 may comprise three rigid components also linked by pin and slot joints. Alternatively, the rigid components may be linked by means of an expansion spring. The supporting member 5 may also comprise a resilient material.

In the above described examples, the strain gauge 9 is coupled to the first and second lever members 17, 19 at the location of the parts adjacent the third pivot axis 25. In other examples, the position of the strain gauge 9 may vary, provided that it is arranged to detect displacement of the display 7 relative to the frame either directly or indirectly.

The frame 3 may not be provided with a rectangular cavity having a base 11 and sidewalls 13, 15 as described above. The frame 3 can have any structure that appropriately supports the supporting member 5.

It will be appreciated that the pin and slot arrangement at the third pivot axis 25 may be replaced with a simple pivot.

It will be appreciated also that the strain gauge 9 may be replaced with an alternative force sensor. Suitable force sensors may include resistive polymer pads, FSR (Force Sensitive Resistor) sensors, MEMS (Micro-ElectroMechanical Systems) sensors etc.

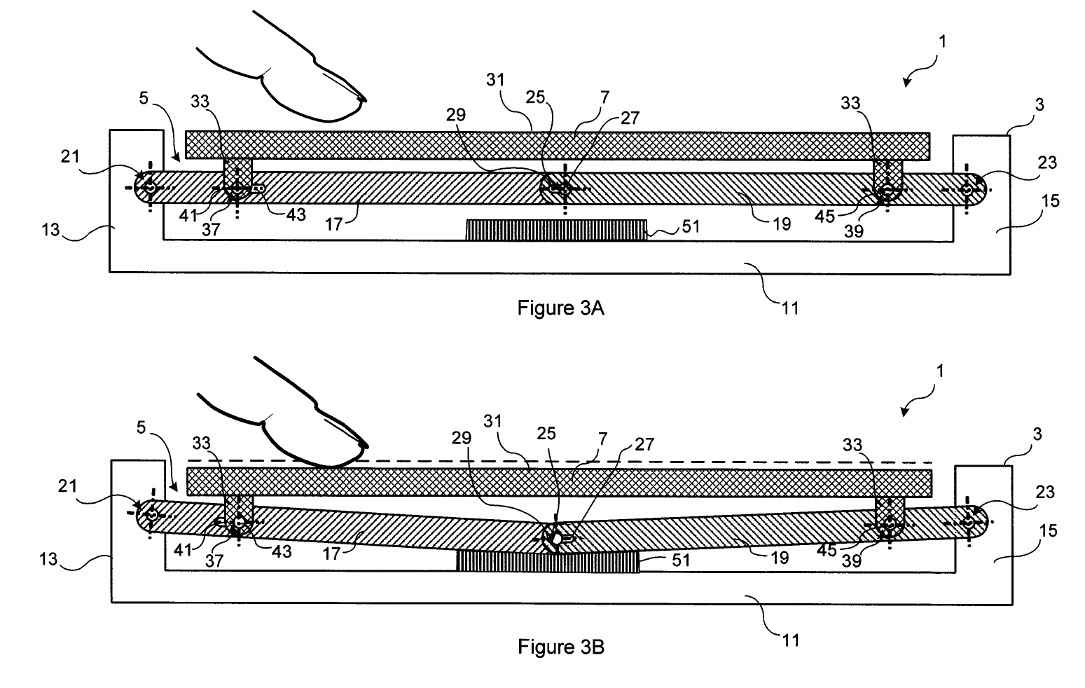

A third embodiment is shown in FIGS. 3A and 3B. The embodiment is largely the same as the embodiment of FIGS. 1A and 1B, and the description of that embodiment is not repeated here for the sake of conciseness. This is one difference in that a pressure sensor 51 is provided in place of a strain gauge. The pressure sensor 51 may be a polymer resistive pad. It may alternatively be a metal composite resistive pad. It may alternatively be a pad comprising carbon particles.

The pressure sensor 51 is located at the base of the frame 11. The pressure sensor 51 is located immediately beneath the third pivot axis 25. Thus, displacement of the display 7 relative to the frame 3 results in the first and second lever members 17, 19 being brought into contract with the pressure sensor 51. This is shown in FIG. 3B. Pressure, i.e. force, results in a change in resistance of the pressure sensor 51. The change is a decrease in resistance with increasing force. The force applied to the pressure sensor 51 can be determined by circuitry (not shown) similar to the circuitry described above in connection with FIGS. 1A and 1B.

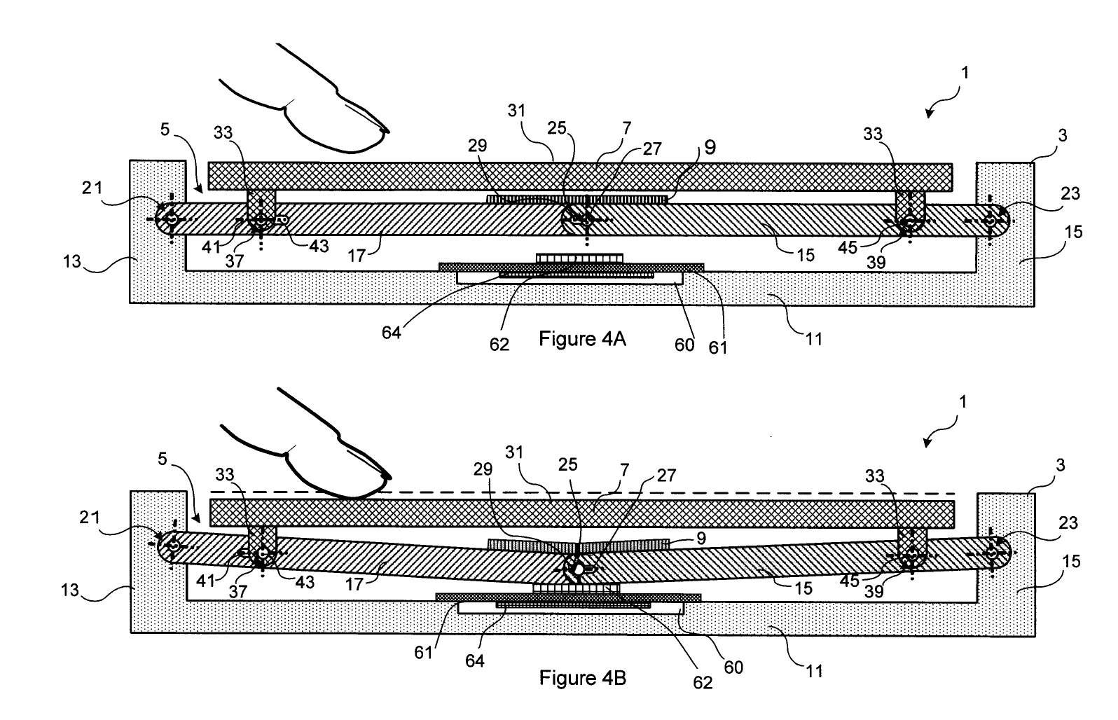

A fourth embodiment is shown in FIGS. 4A and 4B. The embodiment is the same as the embodiment of FIGS. 1A and 1B, and the description of that embodiment is not repeated here for the sake of conciseness, although there are two key differences.

The first difference is that the strain gauge 9 is provided on uppermost surfaces of the first and second lever members 17, 19. This has the effect of leaving the lowermost surfaces empty. A different type of force sensor may be used in place of the strain gauge 9.

The second difference is that there is provided means for providing tactile feedback. In particular, the base of the frame 11 is provided with a recess 60. Spanning the recess 60 is a support 61. The support 61 has ends which rest on the part of the frame 11 surrounding the recess 60.

The support 61 supports on its uppermost surface a coupling component 62. The support 61 supports on its lowermost surface a movement generator 64. The movement generator 64 is a piezoelectric actuator. The piezoelectric actuator 64 is excitable by an electrical signal to move. Thus, when either or both of the first and second lever members 17, 19 is in contact with the coupling component 62, excitation of the piezoelectric actuator 64 results in movement of the display 7 by way of its connection to the piezoelectric actuator 64 through the first and second lever members 17, 19, the coupling component 62 and the support 61. The piezoelectric actuator 64 may be controlled to vibrate, or to generate a single pulse.

Any suitable piezoelectric actuator may be used.

One suitable piezoelectric actuator is a single layer piezoelectric actuator. This includes a ceramic layer and a metal layer. The layers are circular and concentric. The metal layer has the larger diameter. The layers are bonded together. A suitable drive signal may be a pulse width modulation signal. It may be audio or unipolar. It may comprise a single unipolar pulse or a pulse series. Each pulse may have a duration of between 1 and 5 ms. There can be rest periods between pulses as required. Driving signals may be between 50 and 75 V. Driving currents may be around 5 mA. The piezoelectric actuator may be used to generate a signal having a haptic frequency below 1 kHz. The single layer piezoelectric actuator may be rated to around 150V and 200 mA.

Another suitable piezoelectric actuator is a multi layer piezoelectric actuator. For instance, the piezoelectric actuator may include plural ceramic layers, for instance 9 layers, and a single metal layer. The piezoelectric actuator may be a linear device. Such device may be driven by a bipolar voltage between 5 and 10 V. driving current may be 10 mA. The device may be rated to 100 mA. The piezoelectric actuator may be used to generate a signal having a haptic frequency below 1 kHz.

This embodiment allows the device to provide tactile feedback to a user. In particular, the device incorporating the arrangement can be arranged so that the piezoelectric actuator 64 is excited when the device detects, using the output of the strain gauge 9, that the display 7 is displaced relative to the frame 3 to a degree sufficient to constitute a haptic input. Feeling movement of the display 7 resulting from this actuation of the piezoelectric actuator 64 allows the user to determine that their haptic input has been registered.

Since the displacement of the display 7 relative to the frame 3 is uniform across the area of the display 7, the displacement resulting from the piezoelectric actuator 64 is not dependent on the location of contact between the user and the display 7. Put another way, the arrangement provides a uniform tactile feedback.

The tactile feedback aspects of the fourth embodiment are separable from the force sensor aspects of the embodiment.

In the embodiments of FIGS. 1, 2 and 4 described above, the strain gauge 9 is coupled to the pivot connection of the first and second lever members 17, 19. However, it will be appreciated by those skilled in the art that various other mechanisms can be constructed which achieve the same or a similar result and, as such, that this connection of the force sensor may not be essential. Advantageously, a force sensor is connected at a pivot point of an assembly which pivots when the panel 7 moves relative to the frame 3.

Although in the above pivots are achieved using hinges having pins and a cooperating slot or hole, other arrangements are within the scope of the invention. For instance, live or living hinges may be used in place of the pin and hole hinges. A live or living hinge is a (typically thin) strip moulded into a part (typically plastic) to create a line along which the part can bend. Other compliant mechanisms may be used instead.

Other forms of force sensor may be used instead of the strain gauge and pressure sensors described above. For instance, a force sensing resistive (FSR) sensor may be used. As is known, this sensor comprises a semiconductive layer and an electrode layer separated by a spacer layer. As the FSR is subjected to a force, the area of contact between the semiconductive layer and the electrode layer changes, giving rise to a change in resistance. The change in resistance is detected in any suitable way and the force calculated therefrom.

The invention is applicable also to non-display input arrangements. In further embodiments of the invention (not shown in the Figures), an assembly comprises an arrangement substantially as shown in any of the Figures. In place of the display 7 of those Figures, however, a non-display panel is used. The panel comprises a rigid component with a planar upper surface having touch sensitivity. As with the touch-sensitive display of the FIGS. 1A and 1B embodiment, the panel provides output signals from which the location of a haptic user input can be determined. The panel may be provided with pre-printed graphics, for instance denoting the function of keys (direction arrows, numbers, call function keys etc.) which relate to the corresponding area of the panel. The functions provided by user input at the relevant locations on the panel may not change, unlike the touch-sensitive display embodiments.

In a still further embodiment (not shown), a touch-sensitive panel comprising at least one display part and at least one non-display part is used in place of the display 7 of any of the Figures.

Each of these unshown embodiments incorporates the relevant apparatus and operational features from the FIGS. 1, 2, 3 and 4 embodiments and experiences all the advantages thereof. Of course, the resolution (in terms of the resolution of location of a haptic user input) of a non-display touch-sensitive input panel might be significantly lower than the resolution of a touch-sensitive display.

It should be realised that the foregoing examples should not be construed as limiting. Other variations and modifications will be apparent to persons skilled in the art upon reading the present application. Such variations and modifications extend to features already known in the field, which are suitable for replacing the features described herein, and all functionally equivalent features thereof. Moreover, the disclosure of the present application should be understood to include any novel features or any novel combination of features either explicitly or implicitly disclosed herein or any generalisation thereof and during the prosecution of the present application or of any application derived therefrom, new claims may be formulated to cover any such features and/or combination of such features.

1. Apparatus for a terminal device, the apparatus comprising:
a frame;
a panel operable to receive a haptic user input;
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
a force sensor operable to detect a haptic input applied to the panel.

2. Apparatus as claimed in claim 1, wherein the panel is a touch-sensitive input panel operable to receive the location of the haptic user input.

3. Apparatus as claimed in claim 1, wherein the member comprises a plurality of rigid lever members linked to each other by a variable length connection.

4. Apparatus as claimed in claim 1, wherein the member comprises a plurality of rigid components pivotally connected to the frame by a variable length connection.

5. Apparatus as claimed in claim 3, wherein the variable length connection is a pin and slot joint.

6. Apparatus as claimed in claim 3, wherein the member comprises two rigid components connected together at a pivot.

7. Apparatus as claimed in claim 6, wherein the two rigid components are substantially the same size.

8. Apparatus as claimed in claim 6, wherein the force sensor is coupled to both of the rigid components at the location of the pivot.

9. Apparatus as claimed any preceding claim in claim 1, wherein the force sensor is a strain gauge.

10. Apparatus as claimed in claim 1, wherein the frame comprises a base having four sidewalls to define a rectangular cavity, the member being pivotally connected to two opposing sidewalls of said four sidewalls.

11. Apparatus as claimed in claim 1, comprising a transducer operable to provide a tactile feedback to the user through the panel.

12. Apparatus for a terminal device, the apparatus comprising:
a frame;
a panel operable to receive a haptic user input;
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
a transducer operable to provide a tactile feedback to the user through the panel.

13. Apparatus as claimed in claim 12, wherein the member comprises a plurality of rigid lever members linked to each other by a variable length connection.

14. Apparatus as claimed in claim 12 wherein the member comprises a plurality of rigid components pivotally connected to the frame by a variable length connection.

15. Apparatus as claimed in claim 13, wherein the variable length connection is a pin and slot joint.

16. Apparatus as claimed in claim 13, wherein the member comprises two rigid components connected together at a pivot.

17. Apparatus as claimed in claim 16, wherein the two rigid components are substantially the same size.

18. Apparatus as claimed in claim 12, wherein the transducer comprises a piezoelectric actuator.

19. Apparatus as claimed in claim 12, wherein the transducer is supported by the frame.

20. Apparatus as claimed in claim 19, wherein the transducer is in contact with the member when the panel is displaced relative to the frame and is not in contact with the member when the panel is not displaced relative to the frame.

21. Apparatus as claimed in claim 18, wherein the transducer is supported by a deformable component which is supported by the frame.

22. Apparatus as claimed in claim 1, wherein the panel is a touch-sensitive display panel.

23. Apparatus as claimed in claim 12, wherein the panel is a touch-sensitive display panel.

24-46. (canceled)

47. A method of operating an apparatus for a terminal device, the apparatus comprising:
a frame;
a panel operable to receive a haptic user input; and
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
the method comprising using a force sensor to detect a haptic input applied to the panel.

48. A method of operating an apparatus for a terminal device, the apparatus comprising:
a frame;
a panel operable to receive a haptic user input; and
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies,
the method comprising using a transducer to provide a tactile feedback to the user through the panel.
